(19) United States
(12) Patent Application Publication
(10) Pub. No.: US 2006/0209770 A1
(43) Pub. Date: Sep. 21, 2006

(54) Method and apparatus for prevention of unauthorized wireless data communications

(75) Inventors: Jeffrey Monaco, Irwin, PA (US); Steve Varga, Cranberry Township, PA (US); Robert V. Sulkowski JR., Houston, PA (US); Randall P. Morse, Bridgeville, PA (US); Ronald W. Zborowski, Eighty-Four, PA (US)

Correspondence Address: THE WEBB LAW FIRM, P.C., 700 KOPPERS BUILDING, 436 SEVENTH AVENUE, PITTSBURGH, PA, 15219, US

(73) Assignees: Market Central, Inc., Pittsburgh, PA (US); Soltuions4Networks, Pittsburgh, PA (US)

(21) Appl. No.: 11/069,527

(22) Filed: Mar. 1, 2005

(51) Int. Cl. H04Q 7/24

(52) U.S. Cl. 370/338

(57) ABSTRACT

A method and apparatus for preventing unwanted wireless networking data communications includes: a) generating at least one protocol data unit in an apparatus; b) ignoring one or more wireless data transmission signals in the predefined area; and c) transmitting the protocol data unit from the apparatus to the predefined area, whereby a first communications device situated within the predefined area and configured to wirelessly receive the protocol data unit is prevented from transferring data with a second communications device. Furthermore, the protocol data unit is transmitted in a wireless data packet, wherein the wireless data packet conforms to a wireless communication protocol utilized by the first communications device and the second communications device. The apparatus is also configured to transmit the protocol data unit to multiple channels within the channel spectrum utilized by the wireless communication protocol.

### BACKGROUND OF THE INVENTION

1. Field of the Invention

The present invention relates generally to a method and apparatus for preventing unauthorized wireless data communications and, more particularly, for utilizing mechanisms inherent in wireless communication protocols to prevent wireless network data transfers.

2. Description of Related Art

Wireless communication is becoming increasingly prevalent with regard to data transmission between computing devices. Computing devices equipped with the requisite hardware and software may communicate with each other without the need for physical connectivity, such as fiber-optic connections or other wiring, between them. The resultant wireless connectivity is typically used for convenience and cost-savings reasons. Since cables do not need to be run between interconnecting devices, wireless computing devices may be freely moved within the range of the radio transmission capabilities attributed to the devices.

Wireless computing devices either inherently incorporate wireless capabilities or are communicatively connected to hardware configured to provide wireless services. Specifically, these wireless computing devices and hardware utilize various software implemented wireless communication protocols to achieve wireless connectivity. The most common of such wireless communication protocols in use today relate to the IEEE 802.11 specification, including but not limited to the 802.11a, 802.11b, and 802.11g protocols. In addition, other wireless communication protocols are utilized such as Bluetooth.

Continual advancements made in wireless communication technology have resulted in improved wireless computing devices, including increased wireless communication ranges and miniaturization of the wireless computing devices themselves. Additionally, wireless data connectivity has removed environmental limitations that were once associated with data transfer among non-wireless capable computing devices. Unlike a wired environment, radio frequency waves do not conform to physical boundaries and, therefore, sensitive data (e.g., proprietary, confidential, and otherwise) may leak beyond the confines of a given, controlled space and be received by unintended individuals. Additionally, unauthorized personnel may utilize wireless connectivity to connect to wirelessly accessible computer networks. Alternatively, authorized personnel may be knowingly or unknowingly, or intentionally or accidentally, wirelessly transmitting data in circumstances where such wireless data transfer is not permitted. For example, wireless computing devices may connect to each other or to a computer network for amusement or distraction purposes during a meeting, in which it is imperative that no amusement or distraction occur, which would divert the attention of the user of the wireless computing device away from the speaker of the meeting. The aforementioned instances of wireless data communications are but a few of many instances in which it may be desirable to prevent wireless data communications from occurring within a specific environment or circumstance.

Prior art methods of disabling wireless communications include noise-based approaches and hardware-based approaches. For example, U.S. Pat. No. 6,745,018 discloses an active cancellation signal device used to generate an appropriate cancellation signal that can attenuate wireless signals. Additionally, U.S. Pat. No. 6,449,461 discloses how an interference zone utilizing appropriate frequencies may be formed around a communications site to establish communications priorities among communications devices within the interference zone. Furthermore, U.S. Pat. No. 6,496,703 discloses a system for disabling wireless communication devices in a disabling zone. Specifically, a power monitor unit placed within the disabling zone measures the power output produced by the communications device to determine if the device is consistently within the disabling zone or has been removed from the disabling zone.

Drawbacks with the prior art, especially the noise-based approaches, include the limited use and availability of such devices due to restrictions imposed by the Federal Communication Commission (FCC) regulating devices emitting interference signals to obstruct communications. Additionally, implementation of the hardware-based approach prior art devices is complex and would not be conducive to small-scale or ad-hoc applications. Most importantly, however, the hardware-based approach prior art is effective in preventing unwanted wireless communications only after an initial wireless communication has occurred. Thus, some amount of unauthorized communications and/or data transfer has already occurred.

It is, therefore, desirable to overcome the above problems and others by providing a method and apparatus for efficiently preventing initial and continued unauthorized wireless data communications from occurring within a predefined area. Desirably, the apparatus would be simple to operate and would therefore be conducive to ad hoc applications. Additionally, the method and apparatus could be targeted toward specific wireless communication protocols and would not be in conflict with FCC regulations.

### SUMMARY OF THE INVENTION

Accordingly, we have invented a method for preventing unwanted wireless networking data communications within a predefined area including generating at least one protocol data unit in an apparatus, ignoring one or more wireless data transmission signals in the predefined area; and transmitting the protocol data unit from the apparatus to the predefined area, whereby a first communications device situated within the predefined area and configured to wirelessly receive the protocol data unit is prevented from transferring data with a second communications device. Furthermore, the protocol data unit is transmitted in a wireless data packet, wherein the wireless data packet conforms to a wireless communication protocol utilized by the first communications device and the second communications device. The apparatus is also configured to transmit the protocol data unit to multiple channels within the channel spectrum utilized by the wireless communication protocol.

An apparatus for carrying out the aforementioned method is also disclosed. Generally, the apparatus includes a processor configured to generate at least one protocol data unit, wherein the protocol data unit is configured to be processed by a first communications device. The apparatus also includes a transmitter configured to repeatedly transmit the protocol data unit to the predefined area, wherein the apparatus is configured to ignore one or more wireless data transmission signals in the predefined area.

Generally, the apparatus is configured to transmit valid wireless data such that other communications devices utilizing the same wireless communication protocol as the apparatus continually perceive the airspace within the predefined area as “in-use”, and therefore, will not wirelessly transmit data. The present invention utilizes the mechanisms inherent in the specification of the various wireless communication protocols to effectively achieve this result.

Accordingly, the present invention provides a method and apparatus for efficiently preventing initial and continued unauthorized wireless data communications from occurring within a predefined area. The apparatus is simple to operate and is therefore conducive to ad hoc applications. Additionally, the method and apparatus may be targeted toward specific wireless communication protocols and would not result in conflicts with existing FCC regulations.

Still other desirable features of the invention will become apparent to those of ordinary skill in the art upon reading and understanding the following detailed description, taken with the accompanying drawings, wherein like reference numerals represent like elements throughout.

### BRIEF DESCRIPTION OF THE DRAWINGS

FIG. 1 is a diagram illustrating an apparatus for preventing unauthorized wireless data communications and exemplary use thereof within a predefined area; and

FIG. 2 is a flow chart setting forth the basic steps of preventing unauthorized wireless data communications.

### DETAILED DESCRIPTION OF THE INVENTION

The present invention will now be described with reference to the accompanying figures. It is to be understood that the specific system illustrated in the attached figures and described in the following specification is simply an exemplary embodiment of the present invention.

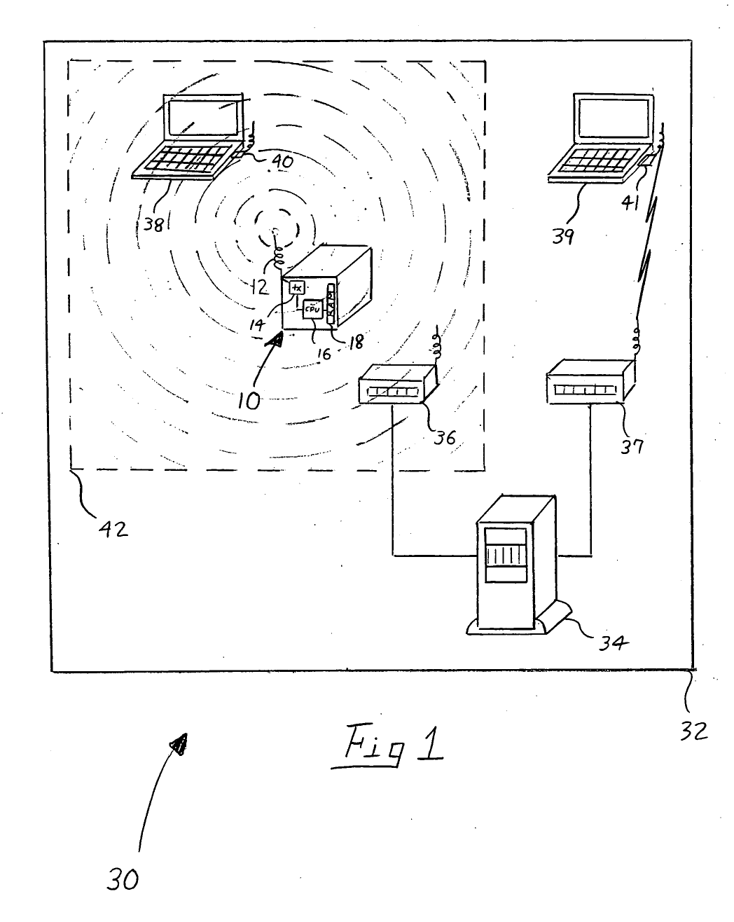

With reference to FIG. 1, an apparatus 10 is shown for preventing unauthorized wireless data communications. In the desirable embodiment, the apparatus 10 is embodied as a stand-alone unit. The size, dimensions, and external appearance of the apparatus 10 may be of any suitable type conducive to the functionality of the apparatus 10. Specifically, the apparatus 10 is sufficiently sized to accommodate the necessary hardware components. It is to be understood that other design criteria including, but not limited to portability and aesthetics, may be considered in the construction of the apparatus 10. In the desirable embodiment, the form-factor of the apparatus 10 is conducive for placement on an open, flat surface, such as a conference room table. Thus, the apparatus may assume a box-like or other rectilinear shape, however, it is to be understood that the shape of the apparatus 10 is not to be construed as limiting the invention.

Desirably, the apparatus 10 includes various components in communicative connectivity with each other including, an antenna 12, a transmitter 14, a processor 16, and a memory 18. The apparatus 10 also includes software operative on the apparatus 10 and stored within appropriate storage mediums within the apparatus 10 including, but not limited to volatile/non-volatile RAM, flash memory, a hard disk drive, an optical drive, or other suitable storage mediums. The antenna 12 may either be an external or an internal antenna depending on the range/quality of signal ratio requirements of the apparatus 10. Furthermore, the antenna 12 may either be an omnidirectional, as shown in FIG. 1, or a directional antenna depending upon the application or purpose of the apparatus 10. As is known in the art, the antenna 12 may be separately connected to the transmitter 14 or may be incorporated with the transmitter 14. The apparatus 10 is configured to not receive any data communications and/or process any received data communications. As is known in the art, an antenna may be configured as a reception antenna, transmission antenna, or both. Thus, the antenna 12 is configured as a transmission antenna only. However, it is to be understood that the reception functionality of a transmission-reception antenna on the apparatus 10 may be modified such that no data communications is passed to the components of the apparatus 10. Accordingly, modifications may be made to the reception functionality of the apparatus 10 either at a hardware or software level, as would be known to those having ordinary skill in the art. It may be possible that the apparatus is constructed of hardware having more than one antenna 12 inherently associated therewith, such as a designated transmission antenna and a designated reception antenna. In such an instance, the reception antenna may be disassociated, such as by removal, from the apparatus 10 to render the apparatus 10 incapable of receiving wireless data communications.

As discussed in reference to the antenna 12, the transmitter 14 may be connected to or incorporated with the antenna 12. The transmitter 14 is configured to repeatedly transmit a wireless signal at various frequencies and modulations in order to support a multitude of wireless transmission protocols and the frequency spectrums associated therewith. It is to be understood that if a receiver is inherently associated with the transmitter 14, the receiver and receiving functions thereof may be modified to render the apparatus 10 incapable of receiving wireless data communications.

Software operative on the processor 16 may reside as firmware on the processor 16 or in other suitable hardware associated with apparatus 10. The processor 16 is configured to generate a protocol data unit conforming to a wireless communication protocol, such as the 802.11 protocol presently widely adopted for wireless network communications. However, it is to be understood that the protocol data unit may conform to other wireless communication protocols either not as widely adopted or not yet implemented. Thus, it is to be understood that the present invention may be utilized in wireless network communications based upon future wireless communication protocols.

For exemplary purposes, the protocol data unit will be discussed in the context of the 802.11 wireless communication protocol. As is known in the art, the protocol data unit may be equated to one or more frame types (e.g., beacon frame) having control fields or data fields containing data responsible for identifying the protocol data unit, indicating source and destination addresses, indicating security features, directing management controls, implementing error-detection, storing substantive data, etc. However, in the broadest sense, all protocol data units of any wireless communication protocol may be viewed as including a header and data. Specifically, the header is configured to cause any receiving communications device utilizing the same wireless communication protocol as the apparatus 10 to identify the protocol data unit as a compatible protocol data unit to be received and processed by the receiving communications device. The data associated with the protocol data unit may be a predefined or a random bit string representative of substantive data. One or more protocol data units may be encapsulated in a wireless data packet. The wireless data packet represents the electronic embodiment of each discernable transmission from the transmitter 14.

The transmitter 14 via the processor 16 is configured to repeatedly transmit the protocol data unit. More specifically, based upon appropriate programming, the protocol data unit may be repeatedly transmitted for a set duration or a practical indefinite duration. For example, each successive protocol data unit may be transmitted no more than 28 microseconds after the most previous transmission of the protocol data unit, however it is to be understood that this specific interval is not to be construed as limiting the actual interval between each protocol data unit. For example, 28 microseconds represents the short inter-frame space (SIFS) utilized by the 802.11 protocol. It is to be understood that the appropriate interval may be selected based upon the interval necessary to keep the airspace of the apparatus 10 as “in-use”. Furthermore, although the processor 16 may be configured to generate variously sized protocol data units, in order to minimize the processing requirements, the processor 16 is desirably configured to generate the protocol data unit according to the largest size permitted by the corresponding wireless communication protocol. For example, at present, the largest size of a protocol data unit transmitted in the context of the 802.11 protocol is 1500 bytes. However, it is to be understood that the size of the protocol data unit is not to be construed as limiting the invention.

As is known in the art, wireless communication protocols may transmit data on various channels. For example, at present, the 802.11b/g protocol is configured to transmit on channels one through eleven in the United States, with other channels available in different parts of the world. However, due to channels having frequency ranges that are sufficiently close to those of adjoining channels, a transmission on any one channel would encompass adjoining channels to a certain extent. Thus, although the apparatus 10 may be configured to transmit on all eleven channels, the apparatus 10 may be configured to only transmit on alternating channels, such as channels 2, 6, and 10 to encompass transmission to all channels supported by the protocol. In the context of two or more channels, such as a first channel and a second channel, the apparatus 10 may transmit the protocol data unit in parallel at simultaneous or offset intervals. In any case, it is to be understood that the apparatus 10 may operate on any of the 802.11 frequency ranges, thereby transmitting protocol data units on one or more of the available channels.

The apparatus 10 may include an internal power supply, such as replaceable batteries, for providing sufficient power required to operate the apparatus 10 as intended. If the apparatus 10 is powered by an internal power supply, the apparatus 10 may also include a low-battery indicator to indicate to a user that operative functionality of the apparatus 10 may imminently cease if the internal power supply is not exchanged or renewed. Alternatively, the apparatus 10 may include an external power source, such as an A/C adaptor and plug. It is to be understood that the apparatus 10 may include both internal power supply and external power supply capabilities.

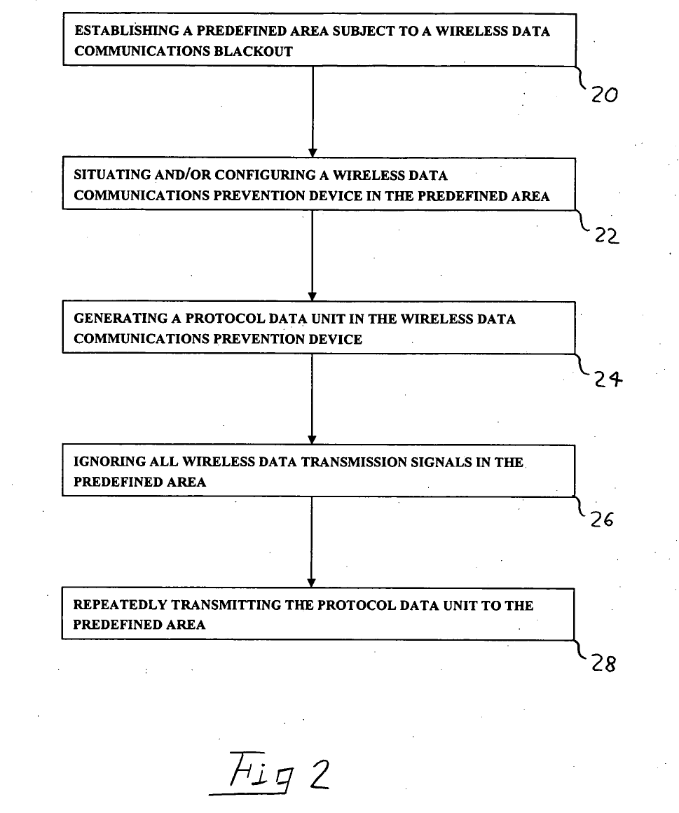

A method for preventing unauthorized wireless data communications in conjunction with the apparatus 10 will now be discussed. With continuing reference to FIG. 1, FIG. 2 depicts a flow chart illustrating the major steps 20, 22, 24, 26, and 28 for implementing the present invention. The present invention is described in connection with an existing wireless network 30, however, it is to be understood that the present invention may be utilized in areas in which no wireless data communications normally occur and in which such a status is to be maintained. The wireless network 30 may exist in a variety of environments including, but not limited to offices, governmental institutions, military institutions, financial institutions, educational institutions, and households. For exemplary purposes, the present invention will be discussed in the context of an office 32. The wireless network 30 in the office 32 may include a server 34 communicatively connected to one more access points, such as wireless routers 36, 37. Various communications devices, such as laptops 38, 39, may be configured with network interface cards (NIC) 40, 41, respectively, to establish communication links with the routers 36, 37 or other access points within range. It is to be understood that other communications devices including, but not limited to personal digital assistants, desktop computers, and telephony devices may be utilized in the wireless network 30 to connect to the routers 36, 37 to communicate with the server 34 and obtain data therefrom.

First, the method includes establishing a predefined area 42 (indicated by a dashed box) subject to a wireless data communications blackout, as shown in block 20. The predefined area 42 is defined as an area in which communications devices are prevented from transferring data. Specifically, if the laptop 38 and the router 36 are situated within the predefined area 42, the NIC 40 is prevented from associating with the router 36. Accordingly, no communications link would be established between the laptop 38 and the router 36, and therefore, no data would be communicated to or from the server. Thus, the wireless transfer of sensitive data may be prevented within the blackout area or predefined area 42.

Second, the method includes situating and/or configuring the apparatus 10 in the predefined area 42, as shown in block 22. Although the predefined area 42 may be determined conceptually, the boundaries of the predefined area 42 are physically established not only by specific placement of the apparatus 10, but also by the specific intensity and/or direction of the transmission from the apparatus 10. For example, as shown in FIG. 1, by placing the apparatus 10 in a centralized location with respect to the router 36 and the laptop 38, utilizing an omnidirectional antenna, and utilizing low intensity transmissions, wireless data communications may be prevented in a uniform area of only a portion of the office 32. Thus, wireless data communications between the router 37 and the laptop 39 would remain unaffected. In an alternative embodiment, a directional antenna transmitting at a high intensity may be utilized to prevent wireless communications from occurring in a particular direction a great distance away. A protected perimeter for allowing authorized communications to occur therein, may also be set up by utilizing an antenna that radiates a pattern over a 180° arc directed outwardly from within the protected perimeter. Accordingly, communications are prevented from entering the perimeter from outside the perimeter and communications are prevented from exiting the perimeter from inside the perimeter. Essentially, a “wall” has been erected for controlling communications into and out of a defined airspace. However, it is to be understood that spatial orientations of the “wall” are not to be considered as limiting the invention. Based upon the aforementioned examples, it is to be understood that the predefined area 42 may be practically defined in an unlimited number of ways, depending on the application of the apparatus 10 and configuration thereof.

The method then includes generating the protocol data unit in the apparatus 10, as shown in block 24. Additionally, the method includes ignoring all wireless data transmission signals in the predefined area 42, as shown in block 26. Furthermore, the method includes repeatedly transmitting the protocol data unit to the predefined area, as shown in block 28. It is to be understood that the steps shown in blocks 24, 26, and 28 are performed relatively contemporaneously to each other. As previously discussed, the apparatus 10 is configured to generate the protocol data unit. Desirably, the protocol data unit is of the largest sizes permitted by the corresponding wireless communication protocol. Although protocol data units having different sizes and containing fields of varying content may be generated, the function of the apparatus 10 may be more efficiently implemented by generating a consistent protocol data unit. Specifically, a single instantiation of the protocol data unit may be transmitted by the apparatus 10, as previously discussed in connection with the capabilities of the apparatus 10, to the predefined area 42.

As is known in the art, wireless communications devices operating within a networking space, such as the wireless network 30, continually “listen” for data transmissions directed to the communications devices and which correspond to the wireless communication protocol utilized by the communications devices. The wireless communications devices will only transmit when no other valid wireless data transmission signals, or protocol data units, are present within the networking space. Specifically, the wireless communications devices utilize a carrier sensing mechanism to “listen” for valid wireless data transmission signals prior to attempting to transmit to the networking space. As long as the wireless communications devices detect the presence of any valid wireless data transmission signals, the wireless communications devices will not transmit to the networking space.

With respect to the present invention, each transmission of the protocol data unit by the apparatus 10 may, in effect, cause the corresponding carrier sensing mechanism of the router 36, the laptop 38, or any other wireless data communications device situated within the predefined area 42 to detect that a valid data transmission signal is present within the predefined area 42. Repeated transmission of the protocol data unit by the apparatus 10, utilizing minimal transmission intervals (e.g., 28 microseconds), and generating large-sized (e.g., 1500 bytes) protocol data units, in effect, results in the router 36 and the laptop 38 continually being denied access to the predefined area 42 of the wireless network 30. Specifically, the router 36 and the laptop 38 will not initiate communications because the router 36 and the laptop 38 are aware that other data is being transmitted within the predefined area 42. Rather, the router 36 and the laptop 38 will wait until a break in the data transmission occurs in the predefined area 42, at which time the router 36 and the laptop 38 may initiate communications of their own. However, due to the repeated and continuous transmission of the protocol data unit by the apparatus 10, no such break in the data transmission will occur. It is to be understood that the apparatus 10 may be considered a wireless data communications device conforming to the wireless communication protocol. Thus, similar to the router 36 and the laptop 38, the apparatus 10, should not transmit a protocol data unit of its own if other data is being transmitted within the predefined area 42. However, the apparatus 10 either lacks or has deactivated the antenna, receiver, or other hardware that would ordinarily be responsible for sensing that other data is being transmitted. Accordingly, the apparatus 10, although conforming to the wireless communication protocol of the other wireless communications devices, will continually transmit the protocol data unit with disregard to the status of data transmission by other wireless communication devices within the predefined area 42

In effect, the present invention utilizes mechanisms inherent in the specification of the 802.11 communication protocol to effectively prevent any wireless data communications devices from establishing a communications link with each other. Inevitably, collisions will occur within the predefined area 42. However, this is of no consequence to the operation of the present invention, as the purpose of the apparatus 10 is to prevent wireless data communications from occurring within the predefined area 42. As shown in FIG. 1, neither the router 37 nor the laptop 39 are situated within the predefined area 42, or range, of the apparatus 10. Thus, neither the router 37 nor the laptop 39 receive the protocol data unit from the apparatus 10 and are therefore immune from any type of wireless data communications blackout imposed within the predefined area 42. Accordingly, ordinary wireless data communications may occur between the router 37 and the laptop 39.

The robust nature of the present invention provides for controlled use of the apparatus 10 in various applications and to varying degrees. As previously discussed, the boundaries of the predefined area 42 may be defined with specificity based upon the intensity of and/or direction in which the apparatus 10 transmits the protocol data units. Additionally, unlike the noise-based approach to preventing wireless communications, the protocol-based approach does not prevent all wireless data communications from occurring within the predefined area 42. Because the protocol data unit is configured for use with a specific wireless transmission protocol and range of frequencies, it is to be understood that wireless data communications conforming to a different wireless communication protocol and range of frequencies are permitted to operate within the predefined area 42. Additionally, timed alterations of transmission frequencies would allow wireless data communications from occurring on certain channels at predetermined intervals. Accordingly, a communications scheme may be implemented in which only wireless communication devices aware of and configured with the communications scheme may engage in wireless data communications. Thus, wireless communications devices not aware of the communications scheme would be unable to wirelessly communicate within the predefined area 42.

Another advantage of the present invention is that the operation of the apparatus 10 may not easily be thwarted from an electronic hacking perspective, as the apparatus 10 either lacks or has deactivated the antenna, receiver, or other hardware that would ordinarily provide a traditional hacking interface.

The invention has been described with reference to the desirable embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method for preventing unauthorized wireless data communications within a predefined area, the method comprising the steps of:
a) generating at least one protocol data unit in an apparatus;
b) ignoring one or more wireless data transmission signals in the predefined area; and
c) transmitting the protocol data unit from the apparatus to the predefined area, whereby a first communications device situated within the predefined area and configured to wirelessly receive the protocol data unit is prevented from transferring data with a second communications device.

2. The method of claim 1, further comprising the step of transmitting the protocol data unit in a wireless data packet, wherein the wireless data packet conforms to a wireless communication protocol utilized by the first communications device.

3. The method of claim 2, wherein the wireless data packet conforms to a wireless communication protocol utilized by the second communications device.

4. The method of claim 1, wherein the one or more wireless data transmission signals are configured to cause a carrier sensing mechanism of the first communications device to cause the first communications device not to transmit.

5. The method of claim 1, wherein the protocol data unit is a frame type that conforms to an 802.11 protocol.

6. The method of claim 1, wherein the protocol data unit includes a header and data.

7. The method of claim 6, wherein the header is configured to cause the first communications device to process the protocol data unit received from the apparatus.

8. The method of claim 6, where the data is one of a predefined bit string and a random bit string.

9. The method of claim 1, wherein the protocol data unit is repeatedly transmitted for one of a set duration and an indefinite duration.

10. The method of claim 9, wherein each successive protocol data unit is transmitted at most 28 microseconds after the most previous transmission of the protocol data unit.

11. The method of claim 2, wherein the size of the protocol data unit is the largest size permitted by the wireless communication protocol.

12. The method of claim 11, wherein the protocol data unit is at least 1500 bytes in size.

13. The method of claim 1, further comprising the steps of:
a) selecting a first broadcast channel; and
b) transmitting the protocol data unit on the first broadcast channel.

14. The method of claim 13, further comprising the steps of:
a) selecting a second broadcast channel; and
b) transmitting the protocol data unit on the second broadcast channel.

15. The method of claim 14, wherein the protocol data unit is transmitted in parallel on the first and second broadcast channel at one of a simultaneous and offset interval.

16. An apparatus for preventing unauthorized wireless data communications within a predefined area, the apparatus comprising:
a) a processor configured to generate at least one protocol data unit, wherein the protocol data unit is configured to be processed by a first communications device; and
b) a transmitter configured to repeatedly transmit the protocol data unit to the predefined area, wherein the apparatus is configured to ignore one or more wireless data transmission signals in the predefined area.

17. The apparatus of claim 16, further comprising an antenna.

18. The apparatus of claim 16, wherein the apparatus is configured to not process any received data communications.

19. The apparatus of claim 17, wherein the antenna is one of an omnidirectional antenna and a directional antenna.

20. The apparatus of claim 16, wherein the apparatus is configured to transmit the protocol data unit in a wireless data packet, wherein the wireless data packet conforms to a wireless communication protocol utilized by the first communications device.

21. The apparatus of claim 16, wherein the one or more wireless data transmission signals are configured to cause a carrier sensing mechanism of the first communications device to cause the first communications device not to transmit.

22. The apparatus of claim 16, wherein the protocol data unit is a frame type that conforms to an 802.11 protocol.

23. The apparatus of claim 16, wherein the apparatus is configured to:
a) select a first broadcast channel and transmit the protocol data unit on the first broadcast channel; and
b) select a second broadcast channel and transmit the protocol data unit on the second broadcast channel.

24. The apparatus of claim 23, wherein the apparatus is configured to transmit the protocol data unit in parallel on the first and second broadcast channel at one of a simultaneous and offset interval.
